(19) United States
(12) Patent Application Publication
(10) Pub. No.: US 2008/0169637 A1
(43) Pub. Date: Jul. 17, 2008

(54) RUB-ON TRANSFER BOOK

(75) Inventors: David Ryan Page, South Jordan, UT (US); Sarah Jacqueline Champion, Orem, UT (US); Mandy Dudley Douglass, Highland, UT (US); Nicole LaRue, Salt Lake City, UT (US); Britt Jane Mitchell, Orem, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: American Crafts, LC, Orem, UT (US)

(21) Appl. No.: 11/622,407

(22) Filed: Jan. 11, 2007

(51) Int. Cl. B42D 1/00; B42D 15/10; B42F 21/00; B42D 15/00

(52) U.S. Cl. 281/38; 283/81; 283/41; 283/67

(57) ABSTRACT

In an application to organize and store decals, an apparatus includes a back portion, a spine, and a cover. A first end of the spine is attached to the back portion. A set of sheets is attached between the back portion and the spine. Each of the sheets is cut to include strips that extend out from the spine. A set of decals is contained on each of the sheets. A first edge of the cover is attached to the back portion. The second edge of the cover is capable of engaging a second end of the spine. The cover is sized to cover the sheets and engage the spine in a closed position and is capable of rotating into an open position to reveal the sheets.

### CROSS-REFERENCE TO RELATED APPLICATIONS

Not applicable.

### BACKGROUND OF THE INVENTION

1. The Field of the Invention

The present invention relates to rub-on transfer decals, and more particularly, to a rub-on transfer book.

2. The Relevant Technology

Rub-on decals are typically sold in sheets. The decals are transferred to a substrate by rubbing the decal onto a substrate, such as a scrapbook, poster board, and the like. The decals are typically used on surfaces that are difficult to print on using a standard inkjet or laser printer. To fix the decal to a surface, a side of the sheet opposite the decal is rubbed or pressed until the decal is transferred from the sheet to the substrate. A hard object, such as a pencil, pen, stick or other tool having a narrow, smooth tip that is known by one skilled in the art or designed for the purpose, can be used to rub the decal onto the substrate.

Each sheet can include multiple decals to provide various patterns and styles from which a user can select. A sheet can have a theme associated with it, for instance, a birthday theme, a holiday theme, a sports theme or other event. A sheet also can be arranged in a particular style, such as a font, border, or accent style. If there are multiple decals on a sheet, the user can select the desired decals and transfer each decal separately to the substrate without transferring any other decals.

The rub-on decals can be manufactured in large volumes or printed on personal inkjet or laser printers from digital images. These decals are printed in sheets. A manufacturer typically will sell a set of these sheets in a shrink-wrapped package. Once a package is opened and a decal is used, it is difficult to store the rub-on transfers in a way to avoid accidental transfer to other substrates. Usually the sheets are stacked on top of each other in a pile and grouped with other papers and miscellaneous items, such as scrap booking supplies.

It is also difficult to sort through multiple sheets to find a desired decal. Some designs are small and hard to find when mixed together with other decals on the sheet. When transferring the decal to a substrate, the whole sheet is placed over the desired transfer location, which makes it difficult to view the substrate to verify the correct transfer location. Large sheets can be burdensome to manipulate over the surface of the substrate to place the decal in the desired location. Users typically cut the sheet around the decal to allow the user to place the cutout portion of the sheet over the desired area for easier placement.

### BRIEF SUMMARY OF THE INVENTION

In an application to organize and store decals, an apparatus includes a back portion, a spine, and a cover. A first end of the spine is attached to the back portion. A set of sheets is attached between the back portion and the spine. Each of the sheets is cut to include strips that extend out from the spine. A set of decals is contained on each of the sheets. A first edge of the cover is attached to the back portion. The second edge of the cover is capable of engaging a second end of the spine. The cover is sized to cover the sheets and engage the spine in a closed position and is capable of rotating into an open position to reveal the sheets.

In another aspect of the invention, a method of making a book is provided for organizing and storing decals. The method includes providing a book including a back portion, a spine, and a cover. The spine has a first end and a second end. The first end of the spine is attached to the back portion. The cover has a first edge and a second edge. The first edge is attached to the back portion. The method also includes cutting a set of sheets having decals to include strips arranged in rows. The sheets are attached between the back portion and the spine with the strips being arranged to extend out from the spine. When in a closed position, the second edge of the cover is engaged with the second end of the spine to cover the sheets. When in an open position, the cover is rotated away from the spine to reveal the sheets.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a front view of a rub-on transfer book in accordance with an embodiment of the present invention;

FIG. 2 is a detail view of the rub-on transfer book of FIG. 1;

FIG. 3 is a perspective view of the rub-on transfer book illustrating an open position; and

FIG. 4 is a perspective view of the rub-on transfer book illustrating decals arranged in strips.

### DETAILED DESCRIPTION OF THE VARIOUS EMBODIMENTS

The embodiments of the present invention include various aspects of a rub-on transfer book. The transfers include a variety of characters, letters, numbers, words, dingbats, accents, borders, symbols, frames, flourishes, and the like. The book is configured to organize and maintain rub-on transfers. The design of the book provides a clear display, ease of use, and convenient storage. The transfers are displayed on one side of the book and an index can be printed on an adjacent side to identify where the transfers are located in the sheets. Each transfer is displayed in rows on individual strips that eliminate the risk of accidental transfers. The strips are bound on one side of the book to keep the transfers together and organized. A flap covers the transfers when the book is closed for storage. Each book can include a theme, style, or group that is identified by indicia on the cover.

The book is used to compile transfers into groups including, for example, a variety of stylish fonts, dingbats, and composed phrases. The transfers can be used to add text, such as a title, or otherwise customize pages in a scrap book or other craft. The transfers can include high quality fonts, exclusive designs, and an assortment of colors.

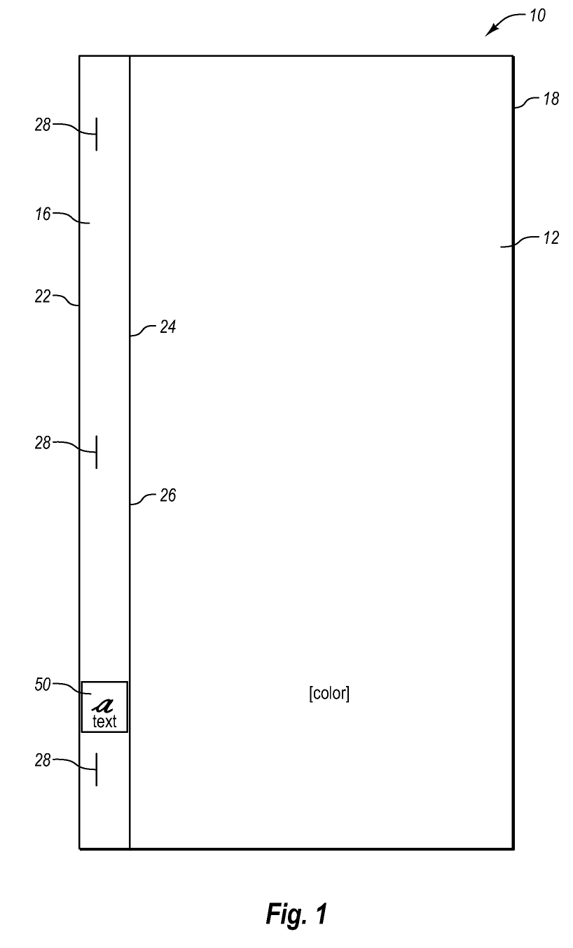

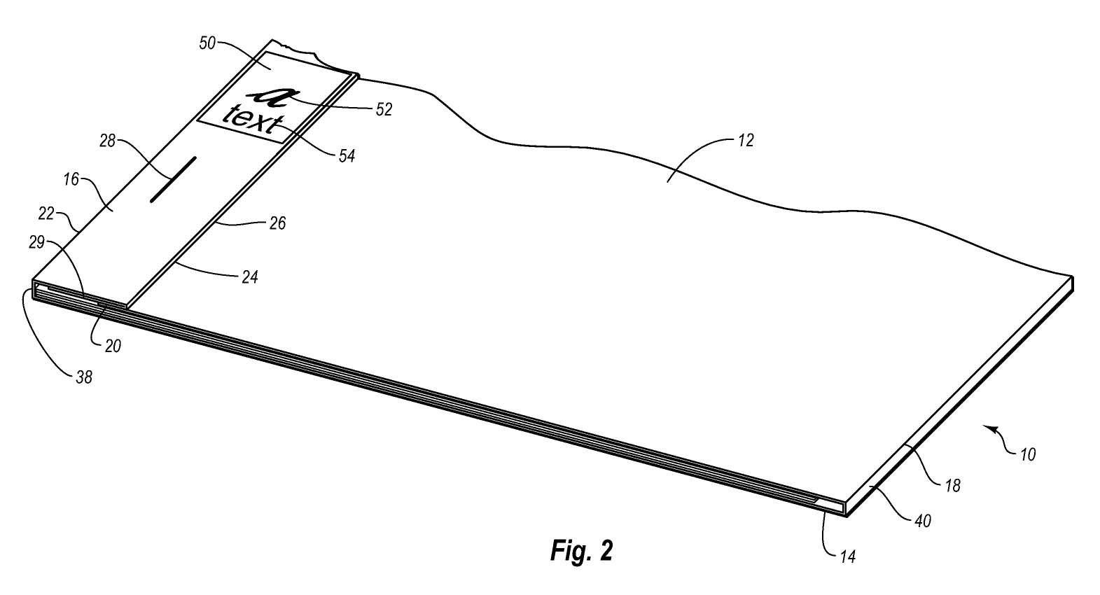

FIGS. 1 and 2 illustrate an embodiment of a rub-on transfer book in accordance with the present invention. The book 10 includes a cover 12, a back portion 14, and a spine 16. The back portion 14 is attached between the spine 16 and the cover 12. The cover 12, back portion 14, and spine 16 can be a single sheet that is bent or folded in a manner to obtain the components of the book or can be made of individual components attached together. The spine 16, for example, can be folded back on top of the back portion 14 and attached to the back portion 14 to maintain a position relative to the back portion 14. The cover 12 can be folded back on top of the back portion 14 on a side opposite the spine 16.

The cover 12 includes a first and second edge 18, 20. The first edge 18 is attached to the back portion 14 and provides movement between an open and closed position. In the open position, the cover 12 is rotated away from the spine 16. And the cover 12 engages the spine 16 in the closed position. The second edge 20 is arranged on an opposite side of the first edge 18 and is free in the open position. The second edge 20 engages the spine 16, for example, by sliding under the spine 16.

The spine 16 includes a first end 22 and a second end 24 opposing the first end 22. The first end 22 is attached to the back portion 14 and fixed to prevent movement relative to the back portion 14. The spine 16 includes a lip 26 on the second end 24. The second edge 20 of the cover 12 can slide under the lip 26 in the closed position to engage the spine 16. The spine 16 is fixed to the back portion 14 with one or more fasteners 28, such as a staple, rivet, pin, clamp, hook, bolt, thread, adhesive, or the like. A reinforcing member 29 can be placed under the spine 16 to stiffen the lip 26. The reinforcement member 29, for example, can be formed by folding the second end 24 of the spine 16 back on itself to create a second layer in the spine 16.

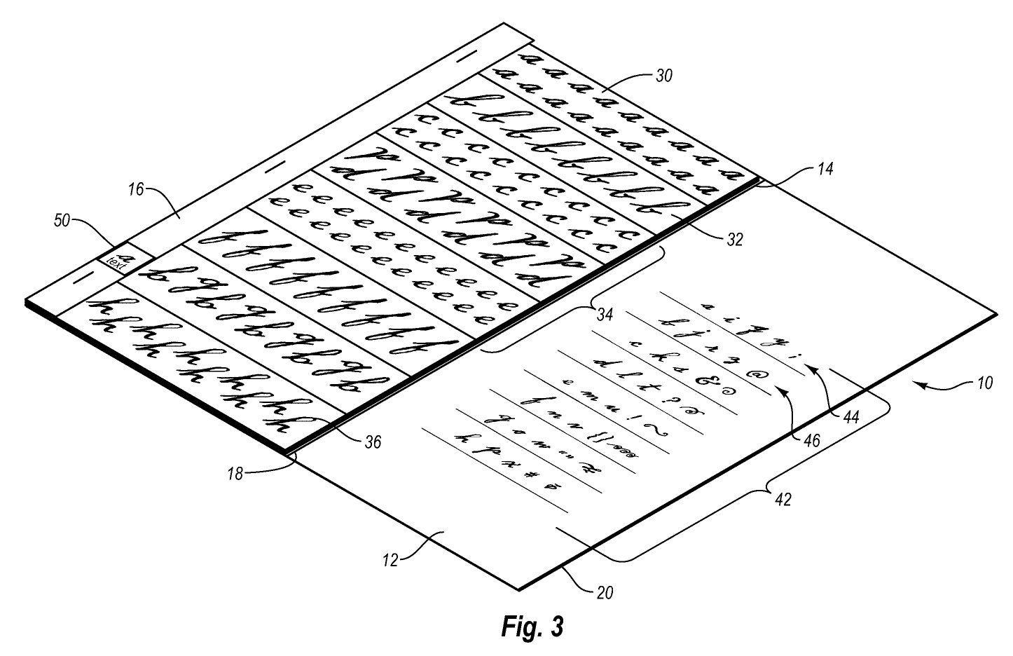

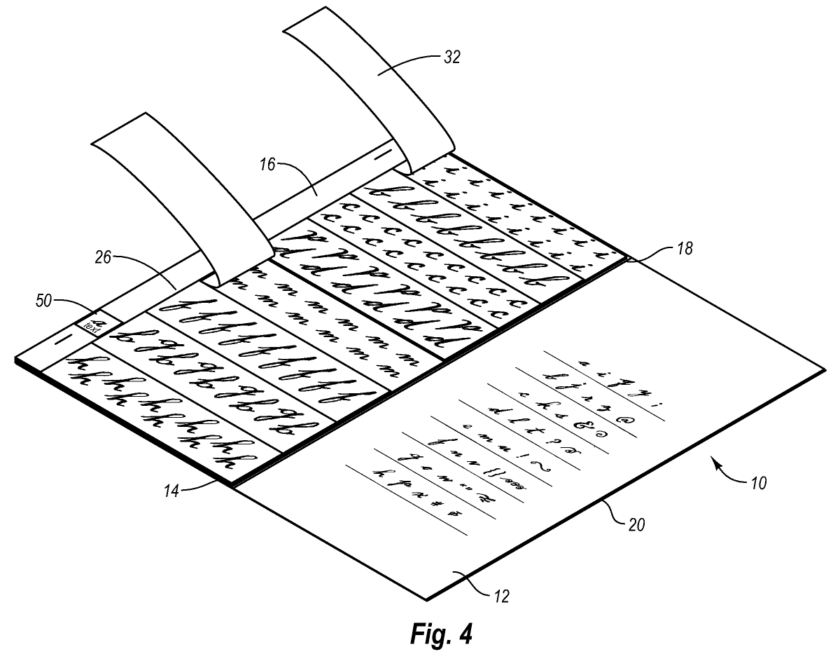

A set of sheets 30 are attached to the spine 16 with the fasteners 28 as illustrated in FIGS. 3 and 4. The fasteners 28, for example, can be staples that are pressed into the spine 16, through the set of sheets 30, and out the back portion 14. Each of the sheets 30 are cut in strips 32. The strips 32 extend out from and are arranged in rows 34 along the spine 16. Each of the strips 32 contain one or more rub-on transfer decals 36 that can be viewed from the front and rubbed off from the back of the sheets 30.

In one exemplary embodiment, the book is made from a plastic, fabric, or heavy paper material, such as card stock that is folded to create a product having overall dimensions of about 6 inches wide by about 11 inches high. The book contains 5 sheets that are each about 6 inches wide and about 11 inches high. Each sheet in this example can be cut into 8 strips that are about 1.375 inches high and 5.25 inches wide to separate the strips from each other. Wax paper is inserted behind each sheet to help prevent the decals from inadvertently rubbing off onto other sheets and the back portion. Each piece of wax paper is cut to the same dimensions as the sheet placed in front of the wax paper. The spine is about 0.75 inch wide and about 6 inches high to span the height of the book. While the spine in this example spans the entire height of the book, the spine also could be cut to have sections or tabs to periodically engage the cover at intermittent points. The cover is about 5.5 inches wide and about 11 inches high and is sized to slide under the lip of the spine. The back portion is about 6 inches wide by about 11 inches high and is sized to contain the sheets.

As illustrated in FIG. 4, a user opens the book 10 by sliding the cover 12 out from under the lip 26 of the spine 16 and rotates the cover 12 to the open position as shown. The user then selects a decal 36 or transfer from one of the strips 32 by looking through the sheet 30. The strips 32 can be flipped up as shown to view decals 36 under the overlying strips.

After the user selects a decal 36 from the book, the user applies it to a surface. The surface should be clean and free of any debris. If desired, the user can cut out individual transfers before transferring it to the surface. The strips 32 are easier to cut than a full sheet because the user can simply cut off an end of the strip to remove a selected decal 36. Alternatively, the strip with the selected decal 36 can be placed over the surface to transfer the decal. Wax paper or tissue backing is placed on the back of the transfers to prevent them from accidentally adhering to objects or other sheets. The backing is removed from the back of the decal before transferring it to the surface. This backing should not be removed or cut away from the unused transfers.

Next, the transfer is placed on the surface that the transfer will be adhered to. The transfer will adhere to most surfaces including, for example, paper plastic, metal, glass, marble, slate, wood, painted surfaces, ceramic, porcelain, wax candles, fiberglass, and the like. The transfer is arranged on the sheet to allow the user to view the transfer face up while rubbing it onto the surface. The transfer is separated from the sheet and fixed to the surface by rubbing or pressing the transfer against the surface. The sheet is then lifted away from the transfer by starting at one corner and rubbing the sheet with the tool while slowly lifting the sheet.

Once complete, the book is placed in the closed or storage position as shown in FIG. 1. In the closed position, the sheets 30 are laid flat against the back portion 14 and the cover 12 is rotated over the top of the sheets 30. The cover 12 is then engaged with the spine 16, for example, by sliding the cover 12 under the lip 26.

The book 10 can also include a first corner 38 positioned between the first end 22 of the spine 16 and the back portion 14. A second corner 40 can be positioned between the first edge 18 of the cover 12 and the back portion 14. The first and second corners 38, 40 are sized to space the cover 12 and spine 16 a distance from the back portion 14. The distance ranges according to the thickness of the stacked set of sheets 30 depending on how many sheets are placed in the book 10. In the example using 5 sheets, the corners 38, 40 are about 0.25 inch from end to end. The corners 38, 40 are made of flexible material or are hinged at the joints to provide a hinged connection between the cover 12 and the back portion 14 and between the back portion 14 and the spine 16. In the example, the corners 38, 40 are bent portions of the card stock.

The book 10 can also include an index 42 as shown in FIG. 3. The index 42 lists the order in which the decals 36 or transfers may be found in the set of sheets 30. Each strip 32 contains the same decal 36. The index 42 identifies the decal 36 on the first sheet and first strip, and then the second sheet and first strip, and so forth until the all decals on the first strip of each sheet are identified in a first row 44. The index 42 then lists the decals on the second strip on a second row 46 of the index 42. In a similar manner, the decal on the first sheet and second strip is identified, and then the second sheet and second strip, and so on until the second row 46 is complete. This process is continued until all the decals on each strip 32 and sheet 30 are identified in their respective row. When a user wants to locate a decal, he or she can first look at the index 42 to find the marking of the decal. Once the marking of the decal is found in the index 42, the user can go to the corresponding row and sheet to find the selected decal.

A label 50 can be added to the spine 16 of the book 10 to identify the theme, style, or group of the decals 36. When the book 10 is in the closed position, the decals 36 cannot be seen by the user. The label 50 identifies the decals 36 when the book 10 is in the closed position. The label 50 includes indicia, such as a representative decal 52 and/or text 54 identifying the theme, style, or group of the decals 36. The index 50 in the exemplary embodiment illustrates the index 50 having an “a” as the representative decal 52 in the decal style. The text 54 is positioned below the representative decal 52 to identify the name of the style. The index 50 is printed directly onto the spine 16, but it can also be affixed to the spine 16 with an adhesive or by any other means known by one skilled in the art to attach the index 50 to the spine 16.

The book 10 can be color coded to correspond to the decal color. A portion or all of the cover 12, back portion 14, and spine 16 can be printed, for example, in black to identify black decals 36. Indicia can also be added to the cover 12 to identify the color, such as adding the word “BLACK” to the cover 12. The decal color can also be identified on the label 50 using a color itself or the name of the color.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. In an application to organize and store decals, an apparatus comprising:
a back portion;
a spine having a first end and a second end, the first end of the spine being attached to the back portion;
a set of sheets attached between the back portion and the spine, each of the sheets being cut to include strips that extend out from the spine, each strip being separated from an adjacent strip at a portion that extends out from the spine and attached to the adjacent strip at the spine;
a set of decals contained on each of the sheets;
a cover having a first edge and a second edge, the first edge being attached to the back portion, the second edge being capable of engaging the second end of the spine, the cover being sized to cover the sheets and engage the spine in a closed position and being capable of rotating into an open position to reveal the sheets.

2. The apparatus of claim 1, further comprising a reinforcing member attached to the spine, the reinforcing member being configured to reinforce an area where the cover engages the spine.

3. The apparatus of claim 1, further comprising a corner attached between the cover and the back portion, the corner providing a space between the cover and the back portion for the thickness of the sheets.

4. The apparatus of claim 1, further comprising a corner attached between the back portion and the spine, the corner providing a space between the back portion and the spine for the thickness of the sheets.

5. The apparatus of claim 1, further comprising an index provided on the cover that lists the order of the decals on the sheets according to rows.

6. The apparatus of claim 1, wherein the decals are organized in a book according to at least one of a theme, a style, and a group.

7. The apparatus of claim 6, further comprising a label provided on the book to identify the decals with indicia.

8. The apparatus of claim 7, wherein the indicia includes a representative decal on the label.

9. The apparatus of claim 7, wherein the indicia includes text of at least one of a theme, a style, and a group.

10. The apparatus of claim 7, wherein the label is color coded to represent the color of the decals.

11. The apparatus of claim 6, further comprising indicia on the book that represents the color of the decals.

12-20. (canceled)
